(19) United States
(12) Patent Application Publication
(10) Pub. No.: US 2008/0103849 A1
(43) Pub. Date: May 1, 2008

(54) Calculating an aggregate of attribute values associated with plural cases

(76) Inventors: George H. Forman, Port Orchard, WA (US); Evan R. Kirshenbaum, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/590,466

(22) Filed: Oct. 31, 2006

(51) Int. Cl. G06F 9/44

(52) U.S. Cl. 705/7

(57) ABSTRACT

To calculate an aggregate of attribute values associated with plural cases, at least one parameter setting that affects a number of cases predicted positive by a classifier is selected. At least one measure pertaining to the plural cases is calculated, where the at least one measure is dependent upon the selected at least one parameter setting. An estimated quantity of the plural cases relating to at least one class is received. The aggregate of attribute values associated with the plural cases is calculated based on the estimated quantity and the at least one measure

### BACKGROUND

In data mining applications, it is often useful to identify categories (or classes) to which data items within a data set (or multiple data sets) belong. Once the classes are identified, quantification can be performed with respect to data items in the various classes, where the quantification is a simple count of data items in each class.

Often, the quantification is performed manually. In other cases, quantification may be based on outputs of automated classifiers. An issue associated with performing quantification based on the output of an automated classifier is that classifiers tend to be imperfect (tend to make mistakes) when performing classifications with respect to one or more classes. Although techniques exist to adjust counts of data items within classes to account for imperfect classifiers, such techniques generally do not allow for accurate computation of other forms of quantification measures.

### BRIEF DESCRIPTION OF THE DRAWINGS

Some embodiments of the invention are described with respect to the following figures:

FIG. 1 is a block diagram that incorporates an attribute aggregation module, according to some embodiments;

FIG. 2 is a flow diagram of a process of performing attribute aggregation, according to an embodiment; and

FIG. 3 is a flow diagram of another process of performing attribute aggregation, according to another embodiment.

### DETAILED DESCRIPTION

In accordance with some embodiments, a mechanism is provided to aggregate an attribute (e.g., cost, profit, time, traffic rate, mass, number of accidents at a location, amount of money owed, hours spent by customer support agents, food consumed, disk space used, etc.) for a subgroup in a data set, where the subgroup can be a subgroup of cases associated with a particular issue (class or category). Note that the aggregate of an attribute can refer to either a subtotal value (value over a subset of cases such as positive cases) or other aggregates such as averages (arithmetic means). A “case” refers to a data item that represents a thing, event, or some other item. Each case is associated with information (e.g., product description, summary of a problem, time of event, cost information, and so forth). Subgroup membership is determined by an imperfect classifier, such as a classifier generated by machine learning.

With an imperfect classifier, it is usually difficult to accurately aggregate some attribute associated with a subgroup of cases (cases belonging to a particular class). However, using a mechanism according to some embodiments, errors made by the imperfect classifier can be recognized and characterized. The characterization made regarding the performance of the classifier can be used to provide a better estimate of the aggregated attribute for the class of interest. The mechanism according to some embodiments can use one of several alternative techniques to perform the aggregation of the attribute of cases in a class.

In an environment where there are multiple classes of interest, the mechanism can be repeated for the different classes. For example, in a call center context, there may be multiple customer issues (different classes) that are present. By repeating the aggregation of an attribute for cases associated with the different issues, an output (e.g., a Pareto chart, graph, table, etc.) can be produced to allow easy comparison of aggregated values (e.g., numbers of hours spent by call agents for each type of known issue, where each type is identified by a separate binary classifier).

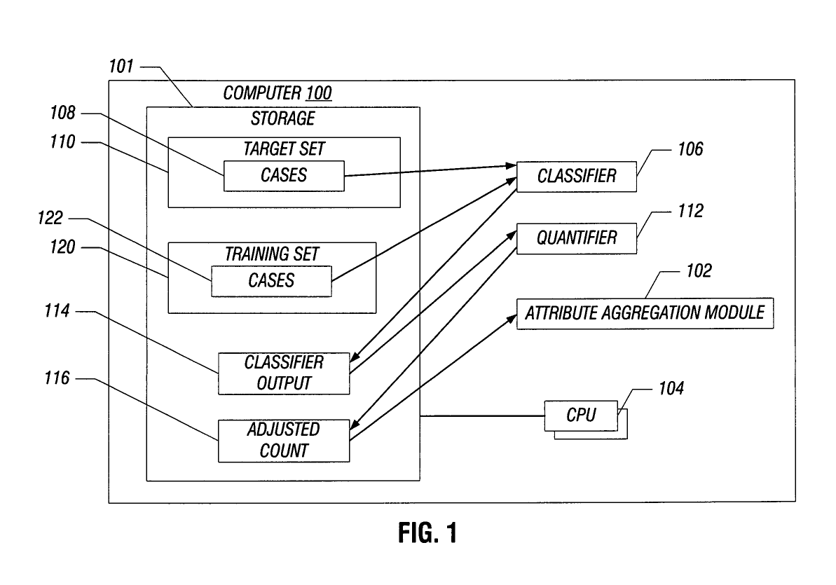

FIG. 1 illustrates a computer 100 that has one or more central processing units (CPUs) 104, where the computer further includes an attribute aggregation module 102 according to some embodiments to aggregate attributes associated with cases in one or more classes. The computer 100 further includes a classifier 106 that is able to perform classification of various cases 108 within a target set 110. The computer 100 also includes a training set 120 of cases 122, which can be used for training the classifier 106. Note, however, that training the classifier and aggregating can be performed on separate computers. The target set 110 and training set 120 can be stored in a storage 101 (or in separate computers).

The classifier 106 can be a binary classifier (that is able to classify cases with respect to a particular class). Also included in the computer 100 is a quantifier 112 that is able to compute a quantity of cases within each particular class. The quantifier 112 is able to use an output 114 of the classifier to calculate an adjusted count 116, where the count 116 is adjusted to account for imperfect classification by the classifier 106.

In one example embodiment, the classifier 106 is a binary classifier (BC) that is trained to classify cases with respect to a particular class. In other words, BC(case x)=1 if the classifier 106 predicts that case x is positive with respect to the particular class. However, BC(case x)=0 if the classifier predicts that case x is negative with respect to the particular class. In some implementations, the classifier 106 can produce a score for a given case, e.g., SC(case x)=0.232. Classification can then be performed by the classifier 106 by applying a threshold function with respect to the scores produced by the classifier 106, e.g., BC(case x)=1 if SC(case x)>threshold t; else 0. The threshold function can indicate, for example, that scores greater than a threshold are indicative of being a positive for a particular class, whereas scores less than or equal to a threshold are indicative of being a negative for the particular class. Many binary classifiers are made up of a scoring function, followed by a threshold test against a learned or default threshold t; for example, Naive Bayes and probability-estimating classifiers use a threshold of 0.5; Support Vector Machines use a threshold of 0.

Given the output 114 produced by the classifier 106, an unadjusted count of positive cases (or of negative cases) can be produced. However, recognizing that the classifier 106 is not a perfect classifier, the quantifier 112 performs an adjustment of the unadjusted count to produce the adjusted count 116 to provide a relatively more accurate count. Various example techniques of producing an adjusted count based on output of a classifier are described in the following references: U.S. Patent Application Publication No. 2006/0206443, entitled “Method of, and System For, Classification Count Adjustment,” filed Mar. 14, 2005; U.S. Ser. No. 11/490,781, entitled “Computing a Count of Cases in a Class,” filed Jul. 21, 2006; U.S. Ser. No. 11/406,689, entitled “Count Estimation Via Machine Learning,” filed Apr. 19, 2006; U.S. Ser. No. 11/118,786, entitled “Computing a Quantification Measure Associated with Cases in a Category,” filed Apr. 29, 2005; George Forman, “Counting Positives Accurately Despite Inaccurate Classification,” 16^{th} European Conference on Machine Learning (October 2005); and George Forman, “Quantifying Trends Accurately Despite Classifier Error and Class Imbalance,” 12^{th} International Conference on Knowledge Discovery and Data Mining (August 2006).

The adjusted count 116 produced by the quantifier 112 is represented as Q, which adjusted count Q is used by the attribute aggregation module 102 according to some embodiments to perform aggregation of some attribute associated with the cases 108. Aggregation of attributes of the cases 108 is further based on other factors, which factors vary according to the particular technique used by the attribute aggregation module 102 in accordance with some embodiments. In some embodiments, there are several alternative techniques that can be employed by the attribute aggregation module 102. Not all of these techniques have to be implemented by the attribute aggregation module 102; for example, the attribute aggregation module 102 can implement just one or some subset less than all of the available techniques discussed below.

A simple technique that can be employed by the attribute aggregation module 102 is referred to as a grossed-up total (GUT) technique. With the GUT technique, the classifier 106 is used to perform classification with respect to the cases 108. Based on the output 114 of the classifier 106, it is determined how many cases are predicted to be positive for a particular class. The number of cases predicted to be positive for the particular class by the classifier 106 is represented as ΣBC, where BC represents a binary classifier (in the implementations where a classifier outputs a score, rather than just “0” or “1”, the sum is of the output of a threshold function that applies the scores against a threshold). The value ΣBC is the unadjusted count of cases in the particular class. An error coefficient, represented as f, is computed as follows:

$$f = \frac{Q}{\sum BC} ,$$

where Q is the adjusted count 116 produced by the quantifier 116. According to the GUT technique, the total cost estimate for cases in the positive class is then ƒ·Σ_{all cases x}cₓ·BC(x), where cₓ represents the cost associated with case x; that is, the sum of the cost of the cases for which the binary classifier predicts positive, multiplied by the factor f.

An issue associated with the GUT technique is that if the trained classifier 106 produces a result that has many false positives, then the aggregated attribute value includes the cost attributes of many negative cases, thereby polluting the aggregated attribute value.

The remaining techniques that can be employed by the attribute aggregation module 102 are able to provide more accurate results than the GUT technique. As noted above, the aggregation of attribute values can produce an aggregate of any one of the following: cost, profit, time, traffic rate, mass, number of accidents at a location, amount of money owed, hours spent by customer support agents, food consumed, disk space used, and so forth.

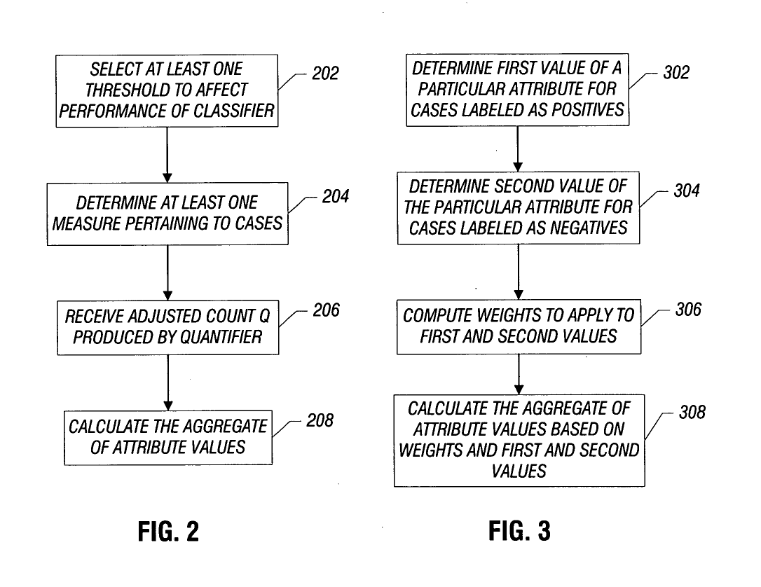

FIG. 2 is a flow diagram of a general attribute aggregation procedure performed by the attribute aggregation module 102 according to some embodiments. Note that there are several different alternative techniques represented by the general attribute aggregation procedure of FIG. 2, including: a “conservative average quantifier” (CAQ) technique; a “precision-corrected average quantifier” (PCAQ) technique; a “median sweep PCAQ” technique; and a “mixture model average quantifier” (MMAQ) technique. Details of these techniques are discussed further below. Each of these techniques uses a classifier that outputs a score.

As shown in FIG. 2, the attribute aggregation module 102 selects (at 202) at least one classification threshold to affect performance of the classifier 106. Alternatively, instead of a threshold, some other parameter setting used in computing the classification can be selected. A “parameter setting” refers to a value selected for a parameter. For example, one way to affect the classification threshold without explicitly selecting the threshold is to adjust the relative costs of false positives versus false negatives (where such relative costs are example parameters) for a cost-sensitive classifier learning algorithm, such as MetaCost. In the ensuing discussion, reference is made to selecting thresholds-note, however, that other parameter settings can be selected in the various techniques discussed below.

The selected classification threshold is the threshold used to compare with scores produced by the classifier 106 for determining whether a case is a positive or negative for a particular class. Selection of the at least one threshold can be performed by a user or by some application executable in the computer 100 or by a remote computer. The selected threshold is different from the natural threshold chosen by the typical classifier training process for the task of classifying individual items (e.g. that used in the GUT technique). The selected threshold is used to bias the classifier to select more (or fewer) positive cases.

Next, at least one measure pertaining to the cases 108 of the target set 110 is determined (at 204), where the at least one measure is dependent upon the selected at least one threshold. For example, the at least one measure can be the average cost of cases, Cₜ (e.g., monetary cost, labor cost, product cost), for cases having scores produced by the classifier 106 greater than the selected threshold (or having some other predefined relationship with respect to the selected threshold). Alternatively, if another attribute (revenue, time, etc.) is being aggregated, then a different measure can be computed (e.g., average revenue, average time, etc.).

The attribute aggregation module 102 also receives (at 206) the adjusted count Q produced by the quantifier 112. The attribute aggregation module 102 then calculates (at 208) the aggregate of attribute values associated with the cases 108, where the aggregation is based on the adjusted count Q as well as the at least one measure determined at 204. In one example, an estimated total cost, represented as T′, is computed as follows: T′=Cₜ*Q. According to the foregoing, the estimated total cost T′ is equal to the multiplication of the average cost (Cₜ) of cases indicated by the classifier 106 as having scores greater than the threshold t, with the adjusted count Q.

With the CAQ (conservative average quantifier) technique, which is one variant of the general attribute aggregation procedure depicted in FIG. 2, the at least one threshold selected at 202 is a more conservative threshold t for the classifier (that is, one that results in fewer cases being predicted to be positive). Selecting a more conservative threshold t reduces false-positive pollution (reduces the number of cases falsely predicted as being positives by the classifier). For some classifiers, selecting a more conservative threshold t means increasing the value of t greater than the natural threshold of the classifier. Selecting an increased value of t causes the classifier to predict a smaller number of cases as being positive, since there will be a smaller number of scores produced by the classifier that would be greater than the more conservative threshold t. In other embodiments in which cases are predicted to be positive if the classifier score is less than the threshold, a conservative threshold might be a value of t less than the natural threshold of the classifier. For embodiments in which a parameter other than a threshold is used, other deviations to the value set during training may be involved to make the classifier more conservative.

Selecting a more conservative threshold t reduces recall to obtain higher precision among cases predicted as being positive. Recall is defined as the percentage of ground-truth positives identified by the classifier, where a ground-truth positive case refers to a case that should be correctly identified as being a positive; in other words, “ground truth” is the “right answer.” Precision means the percentage of positive predictions by the classifier that actually are ground-truth positives (the higher the precision, the less likely the classifier is to incorrectly predict a negative case as a positive case). Recall represents how well the classifier performs in identifying ground-truth positives, whereas precision is a measure of how accurate the classifier is when the classifier predicts a particular case is a positive.

To select a threshold for the CAQ technique, the classifier can be trained and applied to the training cases 122 to determine the number of training cases the classifier predicts to be positive. The threshold can then be adjusted so that half as many cases are predicted as positives. In another approach, the threshold t can be adjusted until the classifier predicts that some fixed number of cases in the target set is positive. Another embodiment of selecting a threshold t is to select a fixed number of the most confident (or positive) cases predicted by a scoring classifier. Alternatively, rather than basing selection of the threshold t based on a fixed quantity of cases, the quantifier can be used to determine how many positive cases there are likely, and then to adjust the threshold so that g*Q cases are predicted positive, where g is some percentage value greater than 0% and less than 100%. In another embodiment, the threshold t can be selected so that the precision Pₜ is estimated to be 95% in cross-validation.

By selecting a more conservative threshold, the at least one measure (e.g., average cost Cₜ) determined at 204 is based on a smaller number of predicted positive cases (which likely includes a smaller number of false positives). By reducing the number of false positives when determining the at least one measure at 204, the at least one measure (e.g., Cₜ) would be more accurate since the contribution of false positives is eliminated or reduced. By enhancing the accuracy of the at least one measure (e.g., Cₜ), the aggregated attribute value (e.g., T′=Cₜ*Q) calculated at 208 is also made more accurate.

Another variant of the general attribute aggregation procedure of FIG. 2 is the PCAQ (precision-corrected average quantifier) technique. With the CAQ technique discussed above, a more conservative threshold t is selected to achieve higher precision of the classifier. However, with the PCAQ technique, in accordance with some embodiments, a less conservative threshold (less conservative than the natural threshold) is selected (at 202). In some scenarios, when a classifier's precision is high and its recall is low, the classifier's precision characterization from cross-validating the training set 120 has higher variance (in other words, the estimate of the precision is less likely to be correct). With the PCAQ technique, a classification threshold is selected with worse precision, but which has a more stable characterization of the precision, represented as Pₜ. Also, by selecting a less conservative threshold, the number of predicted positive cases is increased to assure that a sufficient number of predicted positive cases can be used for computing the at least one measure at 204. Alternatively, with the PCAQ technique, selection of the threshold or other parameter setting is not performed, with the PCAQ technique using the natural threshold (or other parameter setting) of the classifier. Note that a less conservative threshold is desirable when there is a large imbalance between the number of positives and the number negatives.

In one embodiment, precision Pₜ is computed as follows:

Pₜ=q*tprₜ/(q*tprₜ+(1−q)*fprₜ), (Eq. 1)

where tprₜ is the true positive rate and fprₜ is the false positive rate of the classifier 106 at threshold t. The true positive rate is the likelihood that a case in a class will be identified by the classifier to be in the class, whereas a false positive rate is the likelihood that a case that is not in a class will be identified by the classifier to be in the class. The true positive rate and false positive rate of the classifier 106 can be estimated during a calibration phase in which the classifier 106 is being characterized by applying the classifier to cases for which it is known whether or not they are in the class. In one example, the true positive rate and false positive rate of a classifier can be determined using cross-validation. Also, in Eq. 1 above, the value of q is defined as

$$q = \frac{Q}{N} ,$$

where N is the total number of cases 108 in the target set under consideration. The parameter q is the quantifier's estimate of the percentage of positive cases in the target set. Since selecting (at 202) a less conservative threshold has reduced the precision of the classifier (by increasing the number of false positive cases that are considered when determining the at least one measure at 204), adjustment of the at least one measure is performed to account for the reduced precision of the classifier. In one example, the adjusted at least one measure is the precision-corrected average cost of a positive case, represented as C_{pc}⁺, which estimates the true, unknown average cost C⁺ of all cases that are positive in ground-truth. The precision-corrected average C_{pc}⁺ is computed as follows:

$$precision \text{-} corrected average {C}_{pc}^{+} = \frac{( 1 - q ) {C}_{t} - ( 1 - {P}_{t} ) {C}_{all}}{{P}_{t} - q} \qquad ( Eq . 2 )$$

where Cₜ is the average cost of cases predicted positive using threshold t (or, if appropriate, having scores below threshold t or otherwise determined to be in the class based on the non-threshold parameter), and Cₐₗₗ represents the average cost of all cases 108 in the target set. With the PCAQ technique, several measures are computed at 204 that are dependent upon the selected classification threshold t: C_{pc}⁺, Cₜ, and Pₜ.

Given the precision-corrected average C_{pc}⁺, the estimated total cost T′ is computed (at 208) as follows: T′=C_{pc}⁺*Q.

In selecting the threshold t for the PCAQ technique, the threshold t can be selected to be a value where fprₜ=(1−tprₜ), or at least as close as possible given the available training data in the training set 120. Other techniques of selecting the threshold t are described in U.S. Ser. No. 11/490,781, referenced above.

In a different variant of the attribute aggregation procedure of FIG. 2, a median sweep PCAQ technique is used, where multiple thresholds are selected (at 202) rather than just a single threshold. The median sweep PCAQ technique sweeps over several thresholds and selects the median of the plural PCAQ estimates of C⁺. In other embodiments, other values can be calculated from plural PCAQ estimates of C⁺, including any one of the following: calculating an arithmetic mean; calculating a geometric mean; calculating a mode; calculating an ordinal statistic different from the median (for example, a 95^{th} percentile value or a minimum); and calculating a value based on a distribution parameter, such as a value a certain number of standard deviations above or below the arithmetic mean. In other words, for each of the plural thresholds, the precision-corrected average C⁺ value is calculated according to Eq. 2, and a median value or average value of the multiple C⁺ values is computed, where the median value (or arithmetic mean, geometric mean, or mode value) is represented as C̅⁺. With this technique, the measures computed at 204 that depend upon selected thresholds include: C̅⁺, various C⁺ estimate values, various Cₜ values, and various Pₜ values. Using the value of C̅⁺, the estimated total cost is calculated according to T′= C̅⁺*Q.

In another alternative, instead of an average over all the C⁺ values at the multiple thresholds, the average can be an average of the C⁺ values with outliers removed. In yet another alternative, C⁺ values can be excluded where any one or more of the following conditions are met: (a) the number of predicted positive cases falls below some minimum number; (b) the confidence interval of the estimated C⁺ is overly wide (the margin of error of the estimated C⁺ exceeding some predetermined threshold); and (c) the precision estimate Pₜ was calculated from fewer than some minimum number of training cases predicted positive in cross-validation. The excluded C⁺ values are considered to have lower accuracy.

With the median sweep PCAQ technique, a benefit of bootstrapping is achieved without the computational cost. Bootstrapping is a statistical technique that operates by repeating an entire algorithm/computation many times on different random samples of data to obtain different estimates, from which an average can be taken to improve the overall estimate. However, conventional bootstrapping techniques come at the expense of performing the entire computation many times. In accordance with the median sweep PCAQ technique, however, the classifier scores for each case need only be computed once, and all that occurs is recomputing the C⁺ estimates (along with Cₜ, and Pₜ) at different thresholds, which can be achieved with relatively small computational expense.

Another variant of the attribute aggregation procedure of FIG. 2 is the MMAQ (mixture model average quantifier) technique. The MMAQ technique is different from the median sweep PCAQ technique in that rather than determining an estimate of C⁺ at each threshold t, a Cₜ curve is modeled over all thresholds using the mixture represented by Eq. 3, reproduced below:

Cₜ=PₜC⁺+(1−Pₜ)C⁻. (Eq. 3)

The variable C⁻ (which represent the average cost of all cases that are negative in ground-truth) and the variable C⁺ are the unknowns in Eq. 3, and Cₜ and Pₜ are computed as described above for many different thresholds (or other parameters). Determining C⁺ and C⁻ is straightforward based on MSE (mean squared errors)-based multi-variate linear regression, and can be solved with many existing solver packages, e.g. MATLAB, SAS, S-plus. Once C⁺ is determined, then the cost estimate can be computed according to T′=C⁺*Q.

As with the median sweep PCAQ technique, the same thresholds can be omitted for the MMAQ technique to eliminate some outliers that have a strong effect on the linear regression. Alternatively, regression techniques can be used that are less sensitive to outliers (such as regression techniques that optimize for L1-norm instead of mean squared error).

FIG. 3 shows a different general attribute aggregation flow for aggregating an attribute value, such as a cost attribute. The FIG. 3 embodiment is referred to as the weighted sum technique. In the weighted sum technique, instead of multiplying the adjusted quantity (Q) by an average cost, such as discussed above, the weighted sum technique instead pays attention to an attribute value associated with each case (positive or negative), and allows the attribute value of each case to contribute to the overall estimate of the attribute value (e.g., cost).

It is assumed that the characterization of the classifier's tpr and fpr (true positive rate and false positive rate) is available, and that the quantifier 112 has estimated that Q (of a total N) cases are in the class. From this, it can be determined that approximately (N−Q)*fpr cases were probably identified incorrectly as positive, and approximately Q*fnr cases were probably identified incorrectly as negatives, where fnr=1−tpr is the false negative rate (the chance that a positive case will be incorrectly labeled as negative).

Generally, according to the flow of FIG. 3, a first value (e.g., first total cost) of a particular attribute is determined (at 302) for cases labeled as positives by the classifier, and a second value (e.g., second total cost) of the particular attribute is determined (at 304) for cases labeled as negatives by the classifier. Next, weights are computed (at 306) to apply to the first and second values. An aggregated attribute value (e.g., total cost) is then calculated (at 308) for the plural cases based on the weights and the first and second values.

In some embodiments, the first cost is represented as T⁺, which represents the total cost for all cases labeled positive by the classifier, and the second cost is represented as T⁻, represents the total cost for all cases labeled negative by the classifier.

Effectively, two curves are constructed, one each over the positive and negative cases, such that the total area under the curve for the positive cases is (N−Q)*fpr, and the total area under the curve for the negative cases is Q*fnr. The weights to be applied to the costs T⁺ and T⁻ are based on the total area under the respective curves for the positive and negative cases. Basically, the estimated cost T′ starts with the initial cost estimate T⁺ (the summed cost of the labeled-positive cases) and subtracts out a first sum that represents an overcount due to false positives (based on the (N−Q)*fpr value), but a second sum is added that represents the undercount due to false negatives (based on the Q*fnr value). In other words,

$$\begin{matrix}{T}^{′} \approx {T}^{+} - {w}^{+} {T}^{+} + {w}^{-} {T}^{-} \\ = ( 1 - {w}^{+} ) {T}^{+} + {w}^{-} {T}^{-}\end{matrix}$$

where w⁺ and w⁻ represent weights on the respective sums. The curves thus reflect estimates of the likelihood that each case is a false positive or a false negative, respectively.

There are several techniques of constructing such curves, with one simple technique assuming that all positive cases are equally likely to be false positives, and all negative cases are equally likely to be false negatives. This results in flat curves, where the weights are w⁺=(N−Q)*fpr/P for positive cases and w⁻=Q*fnr/(N−P) for negative cases, where P is the number of cases labeled positive. From the foregoing, the overall estimated cost T′ is computed as the following weight sum:

$${T}^{′} \approx ( 1 - \frac{( N - Q ) fpr}{P} ) {T}^{+} + \frac{Q \cdot fnr}{N - P} {T}^{-} . \qquad ( Eq . 4 )$$

The T⁺ and T⁻ sum values can be running sums of costs associated with positive and negative cases, respectively, as labeled by the binary classifier 106. The weights in Eq. 5 (the coefficient that is multiplied by T⁺ and the coefficient multiplied by T⁻) can be computed at the end. Effectively, the weights are dependent upon values fpr and fnr that are indicative of a performance characteristic of the classifier.

Alternatively, instead of defining the area under the curve for positive cases as being (N−Q)*fpr, the area under the curve can be represented as Q*tpr. Eq. 4 is modified accordingly.

In an alternative embodiment, rather than keeping running sums of total costs, T⁺ and T⁻ running average costs (one for labeled-positive cases and one for labeled-negative cases) can be utilized instead. In this alternative, the coefficients of Eq. 4 are multiplied by P and (N−P), respectively.

The assumption above that all positive or negative cases are equally likely to be false positives or false negatives, respectively, may not apply in some scenarios. To address this issue, a new quantity Uₓ is introduced to represent a (relative) uncertainty in the labeling—a degree of belief that the binary classifier may have incorrectly labeled case x. In this embodiment, running totals T_{U}⁺ and T_{U}⁻ are weighted sums Uₓ*Cₓ⁺ and Uₓ*Cₓ⁻, respectively, for cases labeled positive and negative, respectively. The values of U⁺ and U⁻ are also computed as the sum of the weights for the cases labeled positive and negative, where U⁺ is the sum of the Uₓ values for cases labeled positive, and U⁻ is the sum of Uₓ values for cases labeled negative. The cost estimate T′ now becomes:

$${T}^{′} \approx {T}^{1} - \frac{( N - Q ) fpr}{{U}^{+}} {T}_{U}^{+} + \frac{Qfnr}{{U}^{-}} {T}_{U}^{-} . \qquad ( Eq . 5 )$$

Note that in the special case (Eq. 4 above), Uₓ=1 for all x, since U⁺=P, U⁻=(N−P), T_{U}⁺=T⁺, and T_{U}⁻=T⁻. More interesting definitions of Uₓ take into account some other property of the case x, such as SC(x), the score produced by the classifier. If the score is indicative of a probability or confidence, then it may make sense to define Uₓ as (1−SC(x)) for positive cases and SC(x) for negative cases. If the decision is made according to some threshold t, then it may make sense to define Uₓ based on the distance between SC(x) and t, reflecting a belief that cases whose scores lie nearest the threshold are more likely to be misclassified. Such a definition may have a linear fall-off with d (distance from threshold), such as with Uₓ being defined as 1−d/t for negative cases and as 1−d/(1−t) for positive cases. Alternatively, an exponential fall-off (e.g., 2^{d}) could be used. Alternatively, more complicated curves could be used instead.

One more complicated scheme (based on the notion of “confidence”) is to partition the scores (produced by the classifier for different cases) into segments and compute (at the time the classifier is characterized), a number representing a degree of confidence regarding the classifier's decision for scores that fall in each of the segments. This can be done by looking at the scores for the labeled training cases and seeing which scores tend to be misclassified. Thus, it might be determined that scores of 0 to 0.4 are always negatives, scores of 0.4 to 0.42 are negatives 95% of the time, scores from 0.42 to 0.437 are negatives 86% of the time, and so forth. Note that there is no assurance that these values are necessarily monotonic. It may turn out that, for one reason or another, there are a number of negative cases that get scores of between 0.72 and 0.74, above our threshold, while there are very few negative case with scores of between 0.65 and 072 or above 0.74.

From determination above correlating scores to uncertainty, a table (or other data structure) can be constructed to map Uₓ values to scores SC. During operation, when the classifier 106 is applied to a target case x and a score SC(x) is obtained, the corresponding value of Uₓ can be obtained by accessing the table.

Note also that Uₓ does not have to be based on SC(x). Uₓ can be based on other factors, such as data associated with the case (including, perhaps the cost field being estimated). Uₓ may also be based on the score produced by some other classifier. For example, if the attribute aggregation module 102 is estimating the cost associated with cases in class X, the module 102 may want to base its belief that the classifier has correctly classified a case as in class X by the score the classifier gets when the classifier is asked if the case is in class Y. Picking the correct other classifier to use may be part of the calibration procedure for the classifier. Alternatively, scores can be ignored, with the module 102 looking at the decisions about the case being determined to be in some combination of several classes. For example, if there are three classifiers X (the class the estimate is being calculated for), Y, and Z, a table of Uₓ values for each of the eight combinations of X, Y, and Z decisions (e.g., in X and Z but not Y) can be constructed. This again, can be determined based on the training sets. If there are a large number of classifiers available, the calibration phase may involve picking the subset of the classifiers to create the table from. Generalizing, the classifiers can be considered to return more complicated decisions (e.g., yes, no, maybe) or the actual scores for each classifiers can be used to induce a continuous space over which a Uₓ function is defined by interpolation.

In some scenarios, cost values may be missing or detectably invalid for some cases. Several of the techniques discussed above estimate the average cost for positive cases (e.g., C⁺) or cases having scores greater than a threshold (e.g. Cₜ). For such techniques, the cases with missing costs may simply be omitted from the analysis. In other words, the estimate of C⁺ or Cₜ is determined based on the subset of cases having valid cost values, and the count Q is estimated by a quantifier run over all of the cases. This can be effective if the cost data is missing at random.

However, if the missing-at-random assumption does not hold, then the missing cost values may first be computed by a regression predictor using machine learning. By using the regression predictor, the missing value of interest for a case can be predicted. In other words, if there is not a value for a field of interest in a case, but there are values for other fields, a model can be used to predict what the value of the field should be. One example of the model is a regression predictor. For example, if there are three numeric fields, A, B, and C, and a cost field X is missing a value, then linear regression can be run to predict the value for the cost field X given the values for A, B, and C (using some linear relationship between X and A, B, C).

Other models can be used in other embodiments.

Some of the above techniques assume that the cost of positive cases is not correlated with the prediction strength of the classifier 106. To confirm this, the correlation between cost and classifier scores over the positive cases of a training set can be checked. For example, the precision of the classifier may be strongest for cases predicted as positives that have high cost values. If this is the case, then some of the techniques above, such as the CAQ technique, can overestimate the overall cost. On the other hand, if the precision of the classifier for the least expensive positive cases is strongest, then that is an example of negative correlation that can result in underestimating the overall cost value. Similar issues arise if the classifier's scores have substantial correlation with cost for negative cases. In some embodiments, the cost attribute of the cases can be omitted as a predictive feature to the classifier. Note that if the average cost for positive cases C⁺ is close to the average cost for all cases (Cₐₗₗ), then the cost field is generally non-predictive, and thus would not be a valuable feature for the classifier anyway. However, if C⁺ is substantially different from C al then the cost field would be strongly predictive and thus it may be tempting to use the cost field as a predicted feature to improve the classifier. However, for purposes of computing more accurate aggregated costs, it is better not to include the cost field as a feature for the classifier. Note that the techniques discussed above are intended to work despite imperfect classifiers.

Instructions of software described above (including the attribute aggregation module 102, classifier 106, and quantifier 1 12 of FIG. 1) are loaded for execution on a processor (such as one or more CPUs 104 in FIG. 1). The processor includes microprocessors, microcontrollers, processor modules or subsystems (including one or more microprocessors or microcontrollers), or other control or computing devices

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
selecting at least one parameter setting that affects a number of cases predicted positive by a classifier;
determining at least one measure pertaining to plural cases, the at least one measure dependent upon the selected at least one parameter setting;
receiving an estimated quantity of the plural cases relating to at least one class; and
calculating an aggregate of attribute values associated with the plural cases based on the estimated quantity and the at least one measure.

2. The method of claim 1, wherein selecting the at least one parameter setting comprises selecting one of: a parameter setting that is more conservative than a natural parameter setting of the classifier; and a parameter setting that is less conservative than the natural parameter setting of the classifier.

3. The method of claim 1, wherein selecting the at least one parameter setting comprises selecting plural parameter settings, and wherein determining the at least one measure comprises determining plural measures corresponding to the plural parameter settings, the method further comprising:
determining a value that is calculated from the plural measures,
wherein calculating the aggregate of attribute values is based on the determined value.

4. The method of claim 3, wherein determining the value comprises one of: selecting a median measure from among the plural measures; calculating an arithmetic mean of the plural measures; calculating a geometric mean of the plural measures; calculating a mode based on the plural measures; calculating an ordinal value of the plural measures; and calculating a value based on a distribution parameter associated with the plural measures.

5. The method of claim 3, further comprising excluding at least one of the plural measures when determining the value.

6. The method of claim 3, wherein determining the value that is calculated from the plural measures is based on a regression technique.

7. The method of claim 1, wherein selecting the at least one parameter setting comprises selecting a less conservative parameter setting, the method further comprising performing an adjustment of the at least one measure to account for reduced precision of the classifier due to selection of the less conservative parameter setting.

8. The method of claim 7, wherein determining the at least one measure comprises computing a first measure, a second measure, and a precision measure, wherein the precision measure represents a precision of the classifier, the first measure is based on cases having scores produced by the classifier having a predefined relationship with respect to the selected parameter setting, and the second measure is computed based on the first measure and the precision measure,
wherein calculating the aggregate of attribute values is based on the second measure.

9. The method of claim 1, wherein determining the at least one measure comprises determining an average cost of cases predicted positive by the classifier, and wherein calculating the aggregate of the attribute values comprises calculating a total cost associated with all the plural cases.

10. A method comprising:
determining a first value of a particular attribute for cases identified as positives for an issue by a classifier;
determining a second value of the particular attribute for cases identified as positives for the issue by the classifier;
computing weights to apply to the first and second values; and
calculating an aggregate of attribute values associated with plural cases based on the weights and the first and second values.

11. The method of claim 10, wherein determining the first value comprises computing a first cost for the identified as positive cases, and determining the second value comprises computing a second cost for the identified as negative cases.

12. The method of claim 11, wherein computing the first cost comprises computing a first total cost for the positive cases, and computing the second cost comprises computing a second total cost for the negative cases.

13. The method of claim 10, wherein computing the weights comprises computing a first weight to apply to the first value and a second weight to apply to the second value, and wherein computing the first weight comprises computing the first weight based on one of a false positive rate and true positive rate of the classifier, and computing the second weight comprises computing the second weight based on a false negative rate of the classifier.

14. The method of claim 10, further comprising:
calculating, for the cases, corresponding uncertainty values representing uncertainties of labeling respective cases,
wherein computing the weights is based on the uncertainty values.

15. The method of claim 14, wherein computing the weights is further based on at least some of a false positive rate of the classifier, a false negative rate of the classifier, and a false negative rate of the classifier.

16. The method of claim 15, wherein calculating the uncertainty values for corresponding cases comprises based on one of: (1) scores produced by the classifier for the cases; (2) distances between the scores and a classification threshold of the classifier; (3) a data structure mapping uncertainty values to scores produced by classifiers applied to training cases; (4) data associated with the cases; (5) scores produced by another classifier; and (6) decisions about cases by a combination of classifiers.

17. Instructions on a computer-usable medium that when executed cause a computer to:
determine at least one parameter that is indicative of a performance of a classifier;
determine at least one measure pertaining to plural cases, the at least one measure dependent upon the at least one parameter that is indicative of the performance of the classifier;
receive an estimated quantity of the plural cases relating to at least one class, wherein the estimated quantity is different from a quantity of cases identified by a classifier as relating to the at least one class; and
calculate an aggregate of attribute values associated with the plural cases based on the estimated quantity and the at least one measure.

18. The instructions of claim 17, wherein determining the at least one parameter comprises one of: (1) selecting at least one classification threshold of the classifier; and (2) determining at least some of a false positive rate, a false negative rate, and true positive rate, and
wherein determining the at least one measure comprises determining at least one of: (1) an attribute value to be multiplied with the estimated quantity to derive the aggregate; and (2) weights to be applied to corresponding attribute values for producing the aggregate.

19. The instructions of claim 17, wherein determining the at least one measure is based on attribute values associated with the cases, wherein at least one of the cases is missing the attribute value, the instructions when executed causing the computer to handle the missing attribute value by one of (1) ignoring the case with the missing attribute value; and (2) predicting the missing attribute value from one or more other attributes associated with the case with the missing attribute value.

20. The instructions of claim 17, wherein determining the at least one measure is based on values of an attribute associated with the cases, and wherein the instructions when executed cause the computer to not apply the attribute as a feature for the classifier.

21. A method comprising:
computing a precision measure that indicates a precision of a classifier;
determining at least one measure pertaining to plural cases;
adjusting the at least one measure based on the precision measure; and
calculating an aggregate of attribute values associated with the plural cases based on an estimated quantity and the adjusted at least one measure.

22. The method of claim 21, further comprising selecting at least one parameter setting that affects the number of cases predicted positive by the classifier.
